(19) United States
(12) Patent Application Publication
(10) Pub. No.: US 2011/0177479 A1
(43) Pub. Date: Jul. 21, 2011

(54) King digs diggin history

(75) Inventor: Maura B. King, North Ridgeville, OH (US)

(73) Assignee: MAURA B. KING

(21) Appl. No.: 12/381,369

(22) Filed: Mar. 11, 2009

(51) Int. Cl. G09B 19/00; A63H 3/00

(52) U.S. Cl. 434/154; 446/268

(57) ABSTRACT

An historical educational game book/box that unearths and chronicles important eras, people, places and events in the past and present. The book contains a set of paints with brush, a scraping tool, a multicolored square or rectangular surface containing or holding miniature replicas to unearth. A brief summary of the historical set is attached to the inside cover of the book/box. After items have been unearthed, the box can be painted and figures and pieces can be stored within.

### BACKGROUND

Children love to dig. There are many fossil and skeleton digs on the market today. The historic dig touches on a time in history that would be interesting to children. I believe that children need encouragement to learn about things of the past. I have found an interesting way to whet their appetites for history. Most dinosaur digs are markets for boys. However, I have found that girls love to dig also. The invention encourages both boys and girls. The different colors and softer textures of the various rocks help in this. Both love to keep “treasures” and both love to paint. At the end of the historical description, the children are also encouraged to go to the local library to look up more information on that particular topic.

Boys and girls love crafts; they like to dig and paint. Our idea is to provide all that and more. Each historical dig will be enclosed in a wooden book. (Other types of boxes are described in Claims section). The book will have a set of paints together with a paint brush, which may also be used as a whisk for brushing) attached on the outside. Inside, the book will have a brief history of the dig they will be doing preferably on a single sheet of glossy paper that fits inside the lid of the book/box. The game is 8″×5″ (may be smaller) and comes with a tool for scraping (a plastic scraper.) Each set will have at least 2 people (play figures) in the lock. The people will be 1 !/2″ tall×½″ wide. The other pieces will be about 2″×1″ wide. Once the children uncover all of the pieces in the dig, they will be able to keep them as treasures in the book/box. They will paint the box using the information in the historical explanation and according to the items they uncovered.

### EXAMPLE SET

“Wagon West” 2 people, male and female in historical clothing, a covered wagon, a horse, an ox, pots and pans, a campfire, a bucket, a large bag of flour. On the outside of the book, they might paint a horse, covered wagon, a campfire, etc. Girls would love this for the small play sets and the fact that their ides of the painting on the box would be their own artistic endeavor. Boys will enjoy painting the boxes of dig topics such as space and wars. (Other examples have been cited previously.)

Examples Directions for Use:

Read history facts first. You are looking for clues to learn some interesting ideas about people from the past. Place a newspaper, wax paper or some sort of covering on a hard surface such as a table or floor. Take your tool (provided) and scrape the surface of your block carefully. Once all the pieces are found, save them in the book and paint it using your imagination and the facts that you have learned HAVE FUN . . . DIGGIN' HISTORY.

Pages 8, 9, 10, cite short information sheets that would be included in a specific game/set.

Specification sheets (drawings) are numbers 11 through 19a.

Inventor—(King, Maura B) has Provisional patent which was filed and acknowledged, Mar. 22, 2008.

### Fairies

Fairies are prevalent in mythical cultures around the world. They are generally described as having magical powers and a humanlike appearance. Many cultures believe they are fallen angels from heaven, some falling onto the earth and some falling into the sea. Folk tales are told of fairies as they appear in stories dating back from medieval times to modern day stories. The Irish believe that fairies were a previously conquered society known as the Tuth De Dannan or people from the goddess of Tuth De Dannan, and were driven into hiding when the Celts invaded Ireland. They also believe they were skilled builders and possessed magical powers. Other cultures believe they have the ability to fly, to cast spells, and to influence the future.

Modern cultures have depicted fairies as young winged females, small in stature. This depiction is much different from the older versions as being angelic beings who were tall and radiant or short, wizened trolls. Various animals have also been depicted as fairies because of their ability to shape shift. The Selkie or seal people is a common example of a shape shifting fairy. Much of the folklore about fairies revolves around protection from their anger by means of the use of cold iron (fairies don't go near it) charms, herbs, or by avoiding locations known to be theirs.

Whatever you may believe, fairies will surely capture our imagination for countless years to come. You can learn more about fairies by visiting your public library.

NOTE: This example and examples on pages 9-9a, and 10-10a are pasted to the inside left of the book/box and give an explanation of the dig which will be accomplished. They are single-spaced and fit the box

### Hoboes

The term “hoboes” had a different meaning to different people. To some it meant a troublemaker, tramp, or bum. To others it meant an adventurer. A hobo himself considered the term to mean a traveler in search of work. Whatever a person's interpretation of the word, it has been claimed that over 250,000 young people “rode the rails” when the depression was in full swing.

Most of the hoboes who took to “free travel” on the railroads did it for a purpose. Many young did not want to be a burden to a family who had no source of income. They were hopping the rails to seek employment or meaningful work traveling from town to town. Not only did the young take to this form of travel, but older persons did as well. They had families to feed, and when work was not available to them in their own towns, they fled in search of work elsewhere.

This form of travel might have been an adventure, but it had risks and serious dangers as well. One could be seriously hurt trying to board a moving train. “Riding the rails” was trespassing, and if the “Bulls,” another term for the railway police caught you, you could be jailed or shot.

In addition, there was a chance for serious disease or even death. A hobo could be locked in a box car suffering heat prostration or death. The box car could be infested with lice and other vermin causing him serious disease. And lastly, and most sadly, the hobo could be preyed upon by vicious hoboes who only “rode the rails” to steal from others.

The hoboes had a lingo of their own. “Flop” was a place to sleep. “Flip” was to board a train; “bone polisher” was a mean dog. “Bullets” were beans; “banjo” meant a small frying pan, etc. Code in the form a signs also a helped a hobo along his way. A sharp teeth sign meant a mean dog lived there. A triangle with hands meant that the owner of the house had a gun. There were many more.

Read more about hoboes, their lifestyle, lingo, signs, and famous hoboes of the past by visiting your public library.

### The Forty-Niners

In 1848, a three inch article appeared in a small California paper. It read that gold was discovered there. That news did not reach the rest of the nation and the world elsewhere until much later. In 1849, the stampede began, and adventurers, the forty-niners, came to California in droves. Some came for the adventure itself, but most came because they envisioned great wealth. Gold was supposed to be lining the streams around Sacramento. One could make a fortune with little more than some hard work, determination, a wash pan, a shovel and a buckskin bag to hold the fortune. The forty-niners left home and family. They were doctors, artisans, farmers, lawyers, foreigners from Australia, Europe and elsewhere, and thieves. They left civilization behind and most endured hardships, injuries, hunger, and back breaking months of hard labor before small amounts of gold dust would line their buckskin bags.

There were two ways to travel, by sea or overland. Traveling overland across the nation required less money. Many forty-niners were farmers who already owned wagons, carts, livestock, and mules. They had crops they had grown themselves and used these for food along the way. They had items they could barter when their supplies ran low. They gathered at one point in Missouri or elsewhere and traveled in groups for protection against hostile Indians. When wagons or carts were lost in the mud or sand, they rode their mules who carried their belongings as well. It took four to six months for the trip and many dropped out along the way.

Those who could afford the cost, traveled by sea from Boston around South America and Cape Horn and up the Pacific Ocean. The trip was costly, anywhere from $300 to $1000. The rough winds caused many to be sick the entire trip which could last up to 120 days.

The cry of the forty-niners was “California or Bust.” To many, it was just that. To find out more about the gold miners, visit your Public Library.

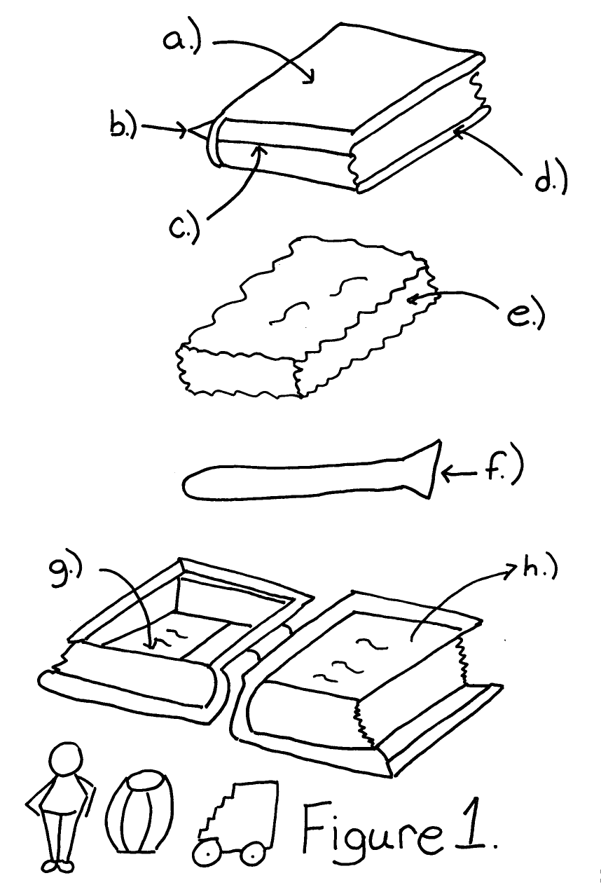

### FIG. 1

| Item | Description |
|---|---|
| a. | Undecorated Lid |
| b. | Hinge |
| c. | Chest |
| d. | Book Box |
| e. | Block (Fits inside bottom of book box) |
| f. | Scraper |
| g. | Educational Piece |
| h. | Block |
| i. | Historical Figures and Accessories and/or |
| | Pieces and Accessories |

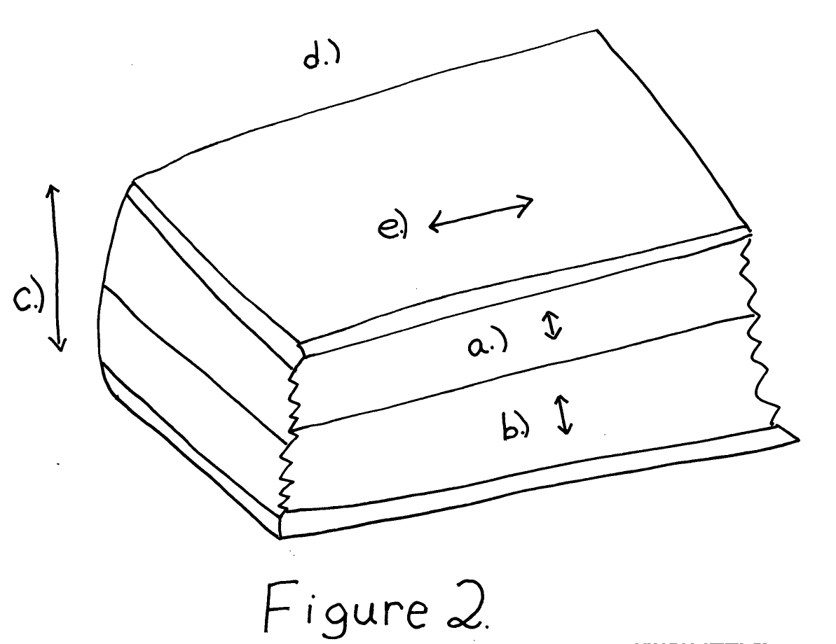

### FIG. 2

| Item | Description |
|---|---|
| a. | Top edge opening 1″ |
| b. | Bottom edge opening 2″ |
| c. | 3″ Height |
| d. | 8″ Wide |
| e. | Box can be a smaller or bigger version |

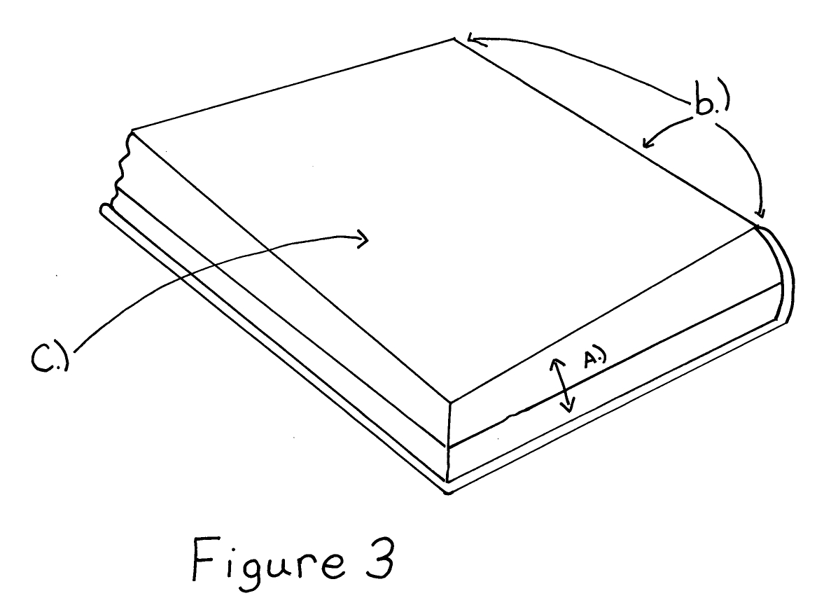

### FIG. 3

| Item | Description |
|---|---|
| A.. | Inside Height 2 and ½″ |
| B. | Hinge |
| C. | Undecorated Box |

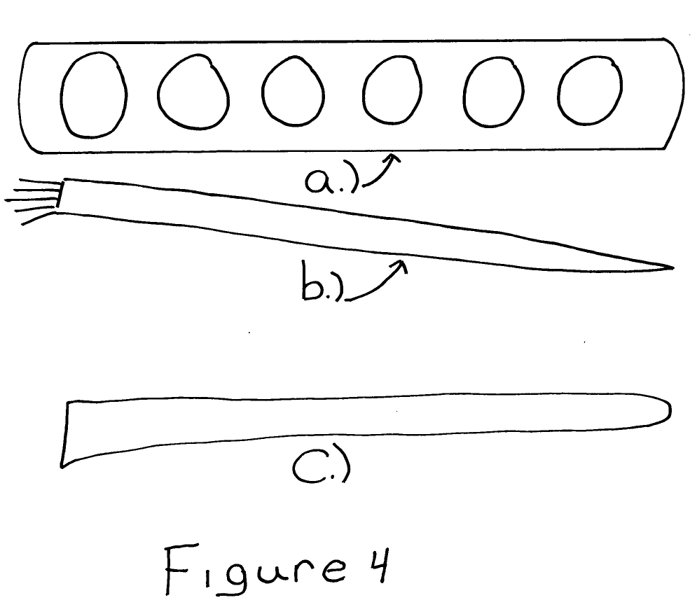

### FIG. 4

| Item | Description |
|---|---|
| A. | Paints |
| B. | Paint Brush |
| C. | Scraper |

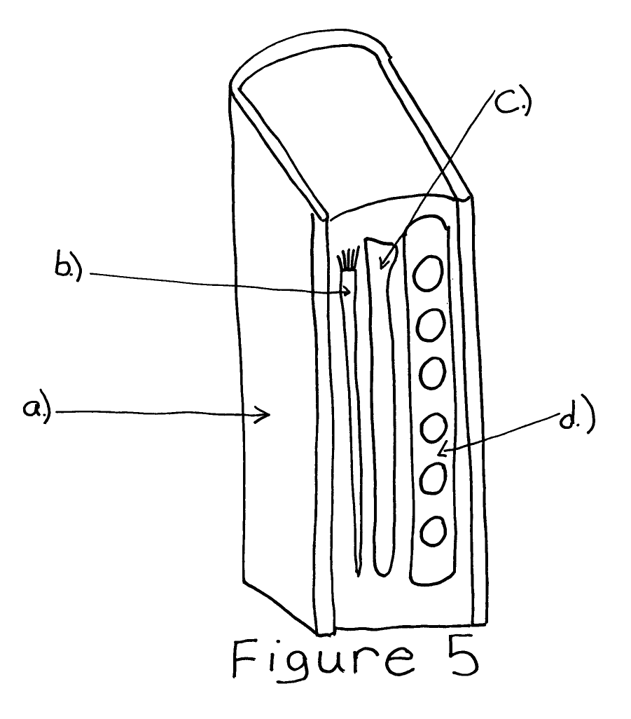

### FIG. 5

| Item | Description |
|---|---|
| A. | Box |
| B. | Paint Brash (attached to side of box) |
| C. | Scraper (attached to side of box) |
| D. | Paints (attached to side of box) |

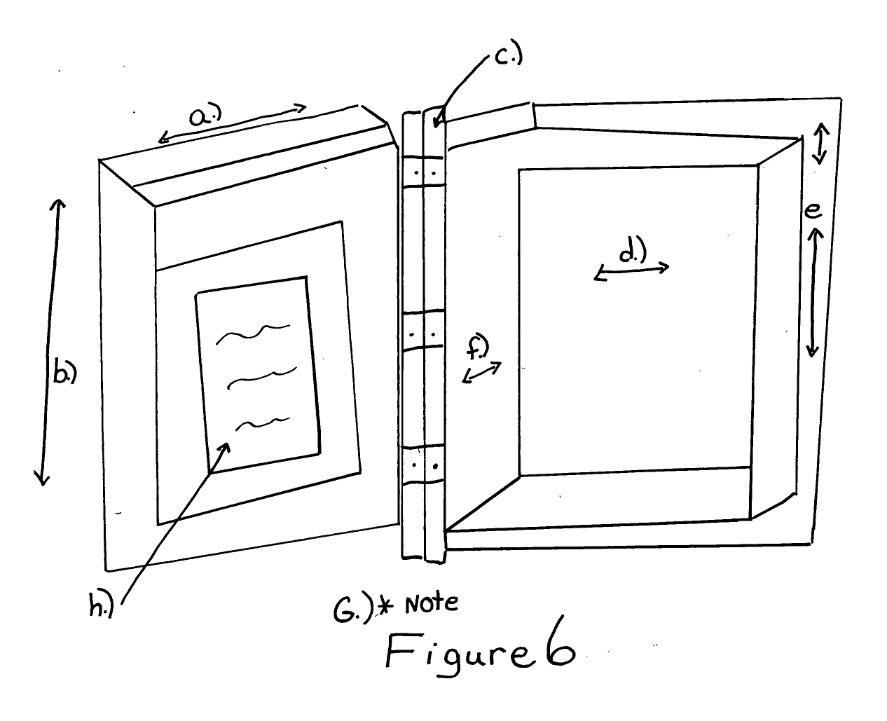

### FIG. 6

| Item | Description |
|---|---|
| A. | 6 and ½″ Width |
| B. | Outside Diameter Height 8 and ½″ |
| C. | Hinge |
| D. | Inside of Box |
| E. | 7 and ½″ Inside Height |
| F. | 2″ Inside Width |
| G. | Box is purchased, may be wood, plastic or |
| | paper and used to hold dig. |
| H. | Information Sheet (about particular historical |
| | dig) |

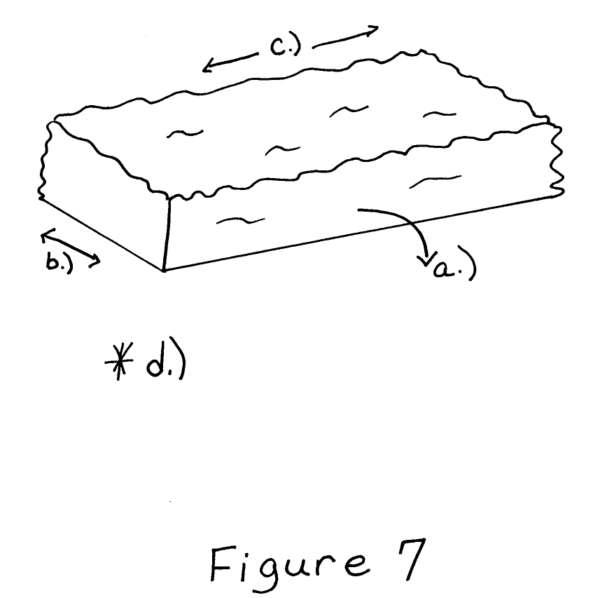

### FIG. 7

| Item | Description |
|---|---|
| A. | Inside block consists of joint |
| | compound, water and sand |
| B. | 2″ Width |
| C. | 7 and ½″ High |
| D. | Block may be small or bigger |

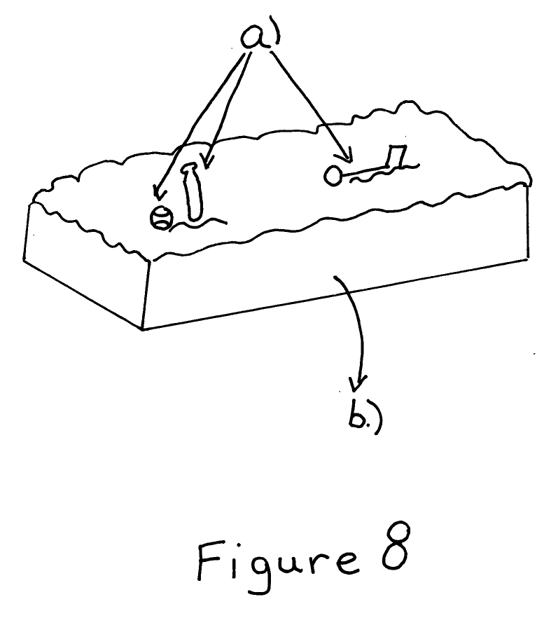

### FIG. 8

| Item | Description |
|---|---|
| A. | Plastic or Metal or Resin Figures and |
| | Accessories |
| B. | Digging Block |

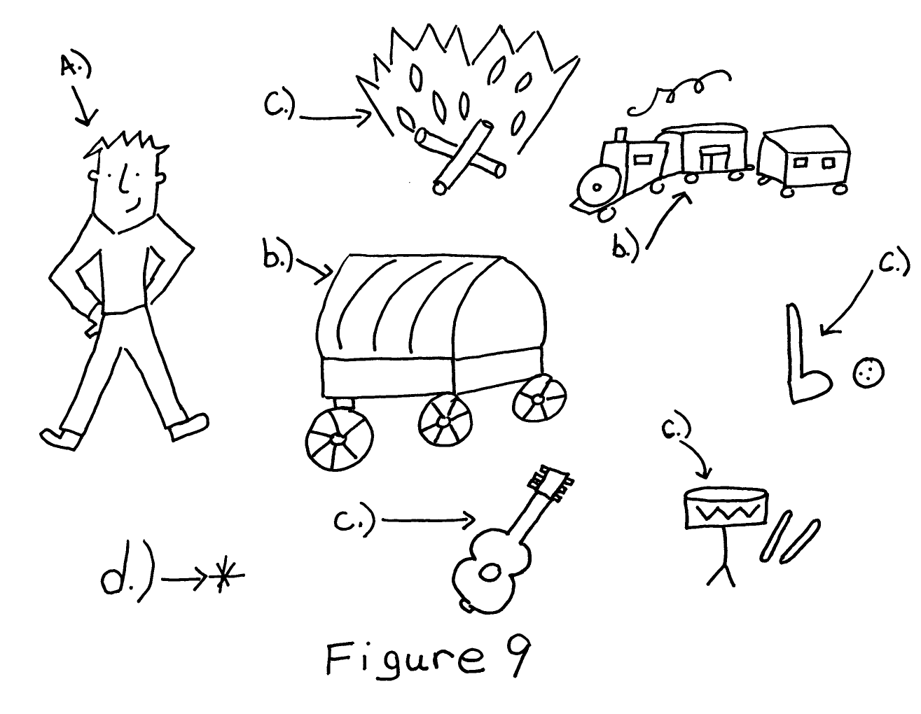

### FIG. 9

| Item | Description |
|---|---|
| A. | Set might include historical figures or people |
| B. | Set might include a train, car, covered wagon, |
| | tepee or other larger items.. |
| C. | Set might include smaller items, such as, baseball |
| | bat, spear, guitar, etc. |
| D. | Not all sets will be alike, depending on the time |
| | period they are depicting. |

1. An educational game/set dealing with a person, an event, time period, sport, holiday, place, and the like.

2. An educational game/set of claim 1 contains one plain (paintable) box with paints and brush supplied. Box preferably shaped as a hollow book, preferably with a hinged lid. For example 6″×8″×3″ (and/or a smaller scaled down version of this)

3. An educational game/set of claim 1 includes a box preferably made of wood but could also be, for example, paper mache, cardboard or plastic (simulated wood) and is shaped like a thick hard-covered bound book or other shape.

4. An educational game/set of claim 1 includes a short educational piece about the topic or “theme” for the game/set.

5. An educational game/set of claim 1 includes a (dig block) that mostly fills the box.

6. An educational game/set of claim 1 includes a block of inventive soft-solid material of various colors depending on the game's topic. For example, green for the grass in the baseball set.

7. An educational game/set of claim 1 includes a block composed of sand, compound, and water in a special inventive mixture.

8. An educational game/set of claim 1 includes a scraper for digging the soft rock. For example, a plastic spatula used in clay modeling.

9. An educational game/set in claim 1 includes a set of colored paints and brush attached to the side of the box.

10. An educational game/set in claim 1 includes people and items unearthed in the theme set. These will be outlined in a specific ideas' sheet attached.
Some of the Inventor's Ideas as Outlined in No. 10 of claim 1
Sports: Baseball, Basketball, Football, Golf, Fishing, Skateboarding, Snowboarding, etc.
Famous Cities: Atlantis, Ancient Rome, etc.
Pirates
Knights
Miners
Hoboes
Hillbillies
Trains
Wagon Trains
Pioneers
Cowboys
Indians: Native Americans, Inuit, Dakota, Pueblo, Cheyenne, Navajo, etc.
Historical Figures: Columbus, Ben Franklin, George Washington, etc.
Depression, WWI, WWII
Time Periods: 1920's, 30's, 40's, 50's, etc.
Civil War: (exploring North/South
Industrial Era
Rock and Roll
Space exploration, race to the moon
Schools: rural one-room schoolhouse, 1790's schoolhouse, etc.
Bible: Genesis/Adam & Eve, Noah, Abraham, Moses, David/Goliath, Jesus, Mary, etc.
Fantasy/Fable/Folklore/Mythology
Holidays: Valentine, Christmas, Easter, Thanksgiving, Hanukah, Ramadan, New Year, Kwanzaa, Halloween
Places/Locales: beaches, oceans, rainforest, jungles, deserts
Baby Shower (includes baby names inside rock)
Tea Party
Examples of Buried Items in Game Set as Outlined in No. 10 of claim 1
The set may contain more or less of the following items
COWBOYS: hat, cowboy, horse, bedroll, spurs, boots, canteen, fire, stars, longhorn
SPACE: asteroid, stars, space suit, moon, rocket ships, space stations
OCEAN: shark, octopus, whale, seaweed, different fish, sunken ship
WAGON TRAIN: captain, kids, wagon, oxen, horse, bag of flour, pots, pans, fire, fiddle, clock
ATLANTIS: mer-people, Poseidon, fish, dolphins, large shells, rock type houses, trees
OCEAN: sunken ship, treasure, seaweed, snorkel, dolphins, shark, octopus, fish
RAIN FOREST: lemur, jungle, tree, animals, canoe, but
PIONEERS: oxen, yolk, buckets, log cabin, material, flint, rifle, dresses, cows, chickens
HOBOES: man, boxcar, cup, plate, silverware, coal, bag, food, bandana
ROCK & ROLL: guitars, albums, microphones, 2 people, drums, piano
BEACH: umbrella, chair, buckets, kids, towels, 2 people, sand
